(19) United States
(12) Patent Application Publication
(10) Pub. No.: US 2026/0121883 A1
(43) Pub. Date: Apr. 30, 2026

(54) METHOD AND SYSTEM FOR VOIP BASED MASS-COMMUNICATION

(71) Applicant: WizRocket Inc., San Francisco, CA (US)

(72) Inventors: Ankur SAINI, Gurugram (IN); Sumantu Mittal, Noida (IN)

(73) Assignee: WizRocket Inc., San Francisco, CA (US)

(21) Appl. No.: 18/925,499

(22) Filed: Oct. 24, 2024

(51) Int. Cl. H04L 12/18; H04M 7/00; H04W 4/16

(52) U.S. Cl. CPC H04L 12/1859; H04M 7/006; H04W 4/16

(57) ABSTRACT

The subject matter of the present disclosure refers a method implemented at a network node in a client server architecture for communicating with a smartphone user based on multi-media data download over a network: delivering a push-notification to a smartphone-based user-device, receiving a media information from the user-device upon receipt of the push notification at the user device; upon receiving the media information from the user device initiating downloading of single or multimedia data file towards the user-device based on determining a configuration of the user device, rendering the push notification as an incoming phone-call alert at the user device upon the downloading, and, rendering voice playback at the user device based on the attending of the incoming call alert and simultaneously displaying an ongoing call interface at the user device, wherein the voice is pre-recorded.

### FIELD OF THE INVENTION

The embodiments discussed in the present disclosure are generally related to voice communication. In particular, the embodiments discussed are related to internet-call based mass-communication.

### BACKGROUND OF THE INVENTION

Users of devices that support multiple users, such as laptops, palmtops, mobile phones, smartphones, multimedia phones, portable media players, GPS units, and mobile gaming systems, often have applications installed that receive periodic notifications from various services. For instance, these applications might include “push” email services (e.g., MobileMe, Microsoft Exchange ActiveSync, Yahoo! Push) or other push services (e.g., update/upgrade services, news feeds, weblogs, podcasts, social networking updates, etc.). These notification messages generally signify events of interest as defined by the applications (e.g., new email alerts, news updates, new podcasts, changes in social networking statuses).

Typically, a notification message is routed through a push-service by identifying both the originating server and the receiving client device. Upon receipt, the client device delivers the notification to the appropriate client application for the user. Often, multiple client applications on the same device may simultaneously await notifications from the same server. When a notification arrives, it triggers each waiting client application. As the number of server applications hosted on the originating server grows to support an increasing number of client applications, valuable processing resources on the client device may be consumed in managing these notifications. Moreover, notifications are currently delivered in a messaging format, which users often disregard, particularly when they hear a messaging tone.

Further, businesses of today need to nudge or alert their end consumers about various alerts such as Update KYC, Your EMI is due, Balance is low, Upcoming trip etc. To handle above mentioned use cases, businesses employ services of cloud telephony or PSTN providers to mass blast a pre-recorded message to a set of end users whose real phone numbers are shared by the business with such providers. However, PSTN calling network is restrictive in terms of sending cost effective yet personalized messages tailored to end user requirements. PSTN is highly restrictive in terms of the scale at which users can be contacted.

When millions of users are to be contacted/updated in a short period of time, a PSTN mass blast campaign which is supposed to happen in 1 hour and should reach 1 mn users with a call. A message duration of about a minute(1) will take 555E1's (PSTN) which would be extremely costly and not many telecom operators can execute. In other words and in an example, if there is a customer who has 10E1's and wishes to contact 1 million users, it normally takes 55 hours to dial out to all those users. Moreover, usage of PSTN for mass blast service requires personal contact numbers of users, thereby not complying with PII data requirement. PSTN providers lack and find it hard to adhere to local govt's rules set for businesses making marketing calls to end consumers. As may be understood, a huge contact number list once uploaded into PSTN dialers leads to employment of physical communication channels, that are normally hard to operate via software or any logic so as to adhere to a time window.

There lies at least a need for a system to execute calls without employing phone numbers or any other personal contact details, and yet achieve such calls as technology, time and cost efficient. Still further, to enhance notification visibility and reduce the likelihood of them being overlooked, there lies a need to present push notifications be presented in a call-like format or an incoming call interface.

### SUMMARY OF THE INVENTION

Embodiments of a method, a corresponding apparatus, and a corresponding system are disclosed that address at least some of the above challenges and issues.

The subject matter of the present disclosure refers a method implemented at a network node in a client server architecture for communicating with a smartphone user based on multi-media data download over a network: delivering a push-notification to a smartphone-based user-device, receiving a media information from the user-device upon receipt of the push notification at the user device, upon receiving the media information from the user device initiating downloading of the meta file and optionally the multimedia data file towards the user-device based on determining a configuration of the user device from the received media information, rendering the push notification as an incoming phone-call alert at the user device upon the downloading.

Based on the attending of the incoming call alert, a voice playback is rendered at the user device based on download of a language file if the configuration of the user device supports a text to speech conversion. The voice playback is rendered based on natural-language voice via an additional multimedia file if the configuration of the user device does not support the text to speech conversion. Otherwise, the playback is rendered based on download of a language file if the configuration of the user device supports a text to speech conversion. Alongside voice playback, an ongoing call interface is simultaneously displayed at the user device.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

Further advantages of the invention will become apparent by reference to the detailed description of preferred embodiments when considered in conjunction with the drawings:

FIG. 1 illustrates a control flow according to an embodiment of the present disclosure;

FIG. 2 illustrates a method according to an embodiment of the present disclosure;

FIG. 3 illustrates an example implementation according to an embodiment of the present disclosure; and

FIG. 4 illustrates a distributed computing-system implementation according to an embodiment of the present disclosure.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

Certain terms and phrases have been used throughout the disclosure and will have the following meanings in the context of the ongoing disclosure.

A “network” may refer to a series of nodes or network elements that are interconnected via communication paths. In an example, the network may include any number of software and/or hardware elements coupled to each other to establish the communication paths and route data/traffic via the established communication paths. In accordance with the embodiments of the present disclosure, the network may include, but are not limited to, the Internet, a local area network (LAN), a wide area network (WAN), an Internet of things (IoT) network, and/or a wireless network. Further, in accordance with the embodiments of the present disclosure, the network may comprise, but is not limited to, copper transmission cables, optical transmission fibres, wireless transmission, routers, firewalls, switches, gateway computers, and/or edge servers.

A “device” may refer to an apparatus using electrical, mechanical, thermal, etc., power and having several parts, each with a definite function and together performing a particular task. In accordance with the embodiments of the present disclosure, a device may include, but is not limited to, one or more IOT devices. Further, one or more IOT devices may be related, but are not limited to, connected appliances, smart home security systems, autonomous farming equipment, wearable health monitors, smart factory equipment, wireless inventory trackers, ultra-high-speed wireless internet, biometric cybersecurity scanners, and shipping container and logistics tracking.

“On-premises” may refer to the software and technology located within the physical confines of a network. An on-premises device may include, but is not limited to, a device located within the physical confines of a network. In accordance with the embodiments of the present disclosure, the term “on-premises” may be used interchangeably with the terms “site,” “office,” or “floor.”

The term “device” in some embodiments, may be referred to as equipment or machine without departing from the scope of the ongoing description.

A “processor” may include a module that performs the methods described in accordance with the embodiments of the present disclosure. The module of the processor may be programmed into the integrated circuits of the processor, or loaded in memory, storage device, or network, or combinations thereof.

“Database” may refer to an organized collection of structured information, or data, typically stored electronically in a computer system.

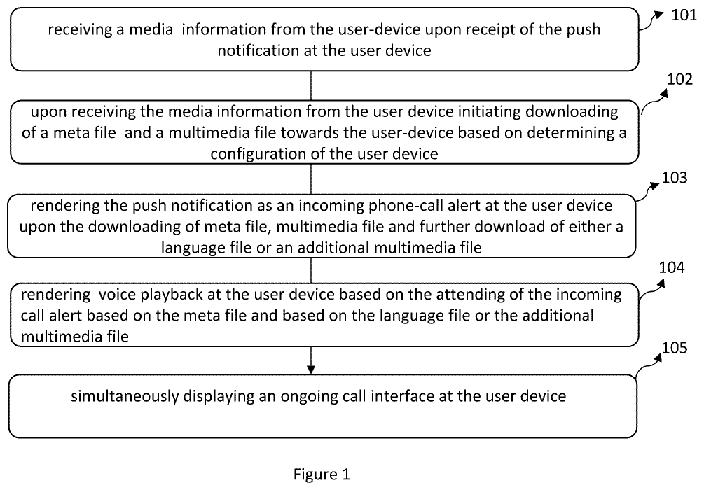

The embodiments of methods, apparatuses, and systems are described in more detail with reference to FIGS. 1-4.

FIG. 1 illustrates a method implemented at a network node or a server in a client server architecture for communicating with a smartphone user based on multi-media data download over a network. The method comprises delivering (step 101) a push-notification to a smartphone-based user-device and receiving a media information from the user-device upon delivery of the push notification at the user device. The push notification is embedded with a URL to a multimedia data file or the additional multimedia file of the pre-recorded voice located at the remote server. The URL may also refer an interactive voice response (IVR) flow.

The receiving of the media information comprise determining the configuration of the user device as at least one of a user preference, a preferred-language, a compatibility with the text to speech conversion, a device capability or a network bandwidth available at the user device.

The method further comprises upon receiving the media information from the user device, initiating (step 102) downloading of the meta file and optionally multimedia data file towards the user-device based on determining a configuration of the user device from the received media information. Such initiating of downloading comprises incorporating a payload within the notification based on download of a language file if the meta file as well as configuration of the user device supports a text to speech conversion. Otherwise, the natural language voice is downloaded based on download of an additional multimedia file if the meta file does not support the text to speech conversion irrespective of configuration of the user device. However, if the meta file mandates the text to speech conversion for call and the user device otherwise incompatible with the text to speech conversion, the process is instantly aborted.

The downloading of the additional multimedia file comprises downloading voice files to provide custom static voice options. The downloading of the language file comprises downloading at least one of: a) a default language file, or b) a user-preferred language file. The user preference may be determined based on at least one of i) the configuration obtained from the user device; and ii) a user-preference obtained from the server or cloud and present into the push notification.

Specifically, the downloading of the language file comprising natural language text triggers generation of voice prompts by an operating system SDK of the user device using a pre-installed text to speech (TTS) engine at the user device, thereby saving data cost as well as battery life as far as pre-recorded voice file is concerned, an enterprise gets a voice file recorded (with the message it wants to deliver to the end consumer) and shares with the server in the networking environment. The generation of the voice prompts from the language-file further comprise generating personalized voice prompts based on user data generated in real time by the user device or user data stored at the server.

The method further comprises rendering (step 103) the push notification as an incoming phone-call alert at the user device upon the downloading. The rendering of the push notification comprises displaying a telephone call ring alert as at least one of a) a telephonic call alert, b) a customer care or a business call alert annotated with rich media text about call intent/context, c) a custom display comprising logo and color annotated with call intent/content, and d) a smartphone operating system phone call application.

The method further comprises rendering (step 104) of the voice playback at the user device based on the attending of the incoming call alert and simultaneously displaying (step 105) an ongoing call interface at the user device. The voice for playback is pre-recorded or generated from text. The rendering the voice playback comprises rendering at least one of a single-party call for conveying information, an IVR call, and, an IVR or non-IVR call with multimedia playback support. Flow of an Automated IVR, system is designed to support Nth level IVR with complex tree structure.

The ongoing call interface is designed based on the operating system SDK to render a phone call display. The ongoing call interface allows the user to provide inputs using at least one of a keypad of the user device, said keypad comprising input keys ranging from digits (0-9), plurality of special characters to provide a user control over the voice playback; and one or more links embedded within the keypad of the call interface to help user navigate within an application of the user device. In an example, the application is invokable based on pressing of the keypad in response to verbal direction imparted during the ongoing call.

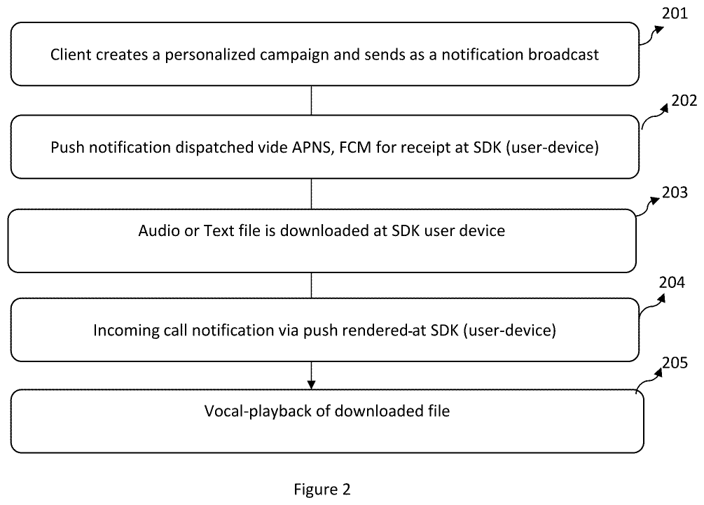

FIG. 2 illustrates an example implementation according to an embodiment of the present disclosure. Specifically, FIG. 2 illustrates an example of FIG. 1 with respect to the underlying control flow. The present subject matter relies on push notifications powered by smartphone providers like Android and ioS (Google and Apple respectively). State of the art or conventional technology employs push-notifications typically to render text/image/GIF's at end user's device when it receives a push notification (PN). On the other hand, the present subject matter uses these PN's to operate like a phone-call on end consumers device. The PN contains the URL to a meta file or a data file, which in turn references a main file that includes content of the campaign.
At step 201, a client creates a personalized-campaign and sends as a notification broadcast vide server.
At step 202, a push-notification is dispatched by the server vide smartphone operating system notification services APNS, FCM as availed by the server, depending upon the operating system of the smartphone of an intended recipient. The dispatched push notification is duly received at the smartphone.
At step 203, an audio or text file is downloaded at SDK user device.
At step 204, the incoming call vide the received push notification is rendered or displayed at SDK (user-device).
At step 205, the vocal-playback of downloaded file is achieved.
The steps 202 till 205 correspond to steps 101 till 105 of the FIG. 1, respectively.

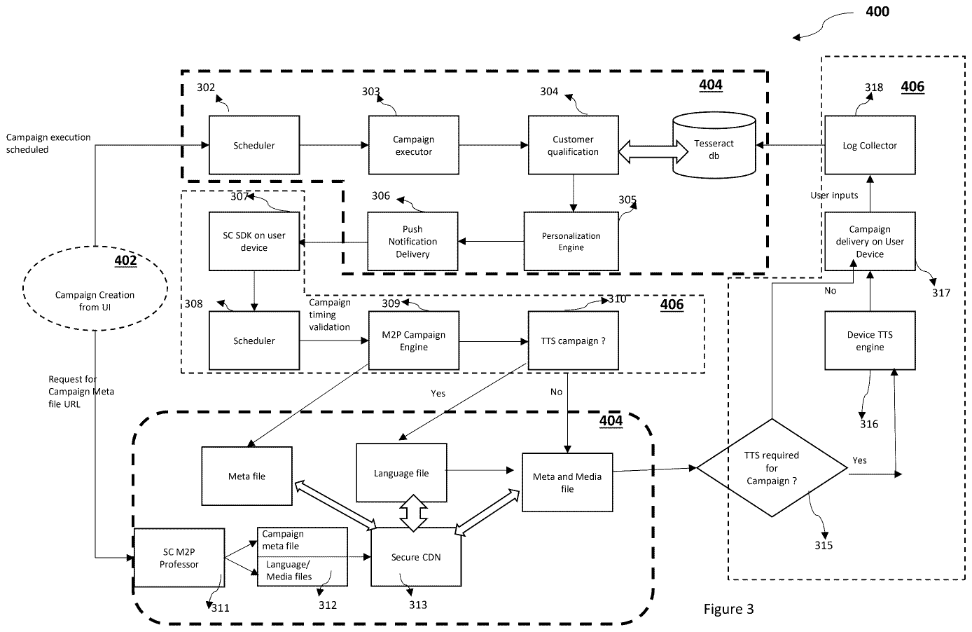

FIG. 3 illustrates a system 400 comprising client device 402, server 404 and a user device 406 based implementation according to an embodiment of the present disclosure. Specifically, FIG. 3 illustrates an exemplary flowchart illustrating the steps involved. FIG. 3 discusses various operations of a method 300 performed in line with method as illustrated in FIG. 1.

Referring to FIG. 3, a campaign in form of an IVR call generated from a user interface or client device 402 at the customer end. A new campaign is created from the dashboard and executed at scheduled time.

At step 302, a notification is scheduled for delivery by the server 404 towards the end user device 406.

At step 303 to 305, the notification is personalized by the server 404 in line with an intended user profile.

At step 306, the notification is directed by the server 404 for receipt as a push notification at the end user device 406 for later signaling of intent for the call during rendering as referred in step 313. In other words, the received push notification is later rendered to look as a phone call at the time of display, thereby maintaining the entire experience of such a call as a real phone call. The push notification is embedded with a URL to a meta file, data file of the pre-recorded voice located at the remote server. The push notification contains the URL for the campaign information meta file. While the campaign runs, push notifications are sent to the users meeting the criteria. The meta file contains the flow for the IVR, basic details about the parameters to be captured, the campaign configured to run with pre-recorded messages or use Text To Speech (TTS) engine to generate message on the runtime. The TTS campaigns support personalisation as well as multiple languages supported by the user's device.

At step 307, an SDK module at the user device 406 (which is a smartphone) is sent the intent to the call, and the server in return receives media stream information for call processing. The media stream information may relate to device capacity of the user device, or a network bandwidth available at the user device.

The steps 302 till 307 jointly refer the step 101 of FIG. 1. Steps 302 till 306 refer steps performed by the server 404 while step 307 is performed by user device 406.

At step 308, the scheduler at the user device 406 schedules or times the notification delivery at the user device such that the user device 406 is configured to later on display an incoming call intent (call screen) , after having completed downloading as referred in subsequent steps.

At step 309, the user device 406 initiates the campaign rendering by initiating downloading of a meta file and a multimedia file. In addition, the language file is downloaded subject to availability of text to speech service (TTS) at the user device. As mentioned earlier with respect to FIG. 1, if the meta file as well as configuration of the user device supports a text to speech conversion then language file is downloaded. Otherwise, the natural language voice is downloaded based on download of an additional multimedia file if the meta file does not support the text to speech conversion irrespective of configuration of the user device. If the meta file mandates the text to speech conversion for call and the user device otherwise incompatible with the text to speech conversion, the process is instantly aborted.

At Step 310, the TTS forming a part of SDK at the user device identifies the user's preferred language, which is set by a Mobile App installed within the user device. Alternatively, the user preference may be sent within push notifications if part of user data on stored at a central location such as dashboard. SDK downloads the corresponding language file if there is one referred by the Meta file, or fallbacks to the default language file and downloads the same. The SDK generates voice prompts based on the messages in the language file. Since the messages are generated on the fly from text or language file, such TTS based mode supports personalisation by including user information such as Name of customer, Birthdate etc. Any information that is being captured or alternatively provided by the Mobile App at runtime can be used for personalization.

At step 311, the server 404 communicates a URL link to the user device 406 remotely access a media file related to the customized campaign as created the device 402 to enable file download by the user device 406 in accordance with the description of Step 310.

At step 312, the language meta file or the multimedia file (as may be applicable and referred by the URL) and pertaining to the campaign are delivered from a remote location for sending to the user device 406 in accordance with the description of Step 310.

At step 313, the URL and metadata from steps 311, 312 undergoes standard encryption for secure communication from the remote location towards the user device 406.

Accordingly, the file(s) are made available for downloading at the user device 406 based on encrypted URL and metadata in accordance with the description of Step 310. The steps 308 till 313 correspond to step 102 of FIG. 1.

Accordingly, an incoming call intent (call screen) is displayed or rendered at the user device as a push notification. Alternatively, the SDK at the user device 406 displays an incoming call notification and follows the IVR flow as provided in the meta file. The rendering of the push notification comprises displaying a telephone call ring alert as at least one of a) a telephonic call alert, b) a customer call alert annotated with rich media text about call intent/context, c) a custom display comprising logo and color annotated with call intent/content; and d) a smartphone operating system phone call application.

At step 315 at the user device 406, in case the user accepts the notification, the file is downloaded from the server either as a text file vide step 316 or voice file vide step 317 subject to availability of TTS. Specifically, as already provided with respect to step 309, the server 404 allows downloading of two forms of media streams at the user device 406. One form is static in the form of voice files, to provide custom static voice options. These files are optimised to keep the network requirements low. Dynamic media streams are actually text which are then converted into Voice using the pre-installed TTS engine at the user device. Both the media streams can support multiple different languages and accents. The step 315 corresponds to step 103 of FIG. 1.

At step 316 at the user device 406, the file is downloaded at the user device 406 as a as a text file subject to TTS availability. With the use of end user devices and TTS, network load is drastically reduced to download file (by allowing text file download instead of voice file), while also allowing personalization to the level of local language(set and available on the device) with personalised content.

At step 317 at the user device 406, the file is downloaded as a pre-recorded voice file at the user device 406 subject to TTS non-availability.

As a result, as a part of voice over internet protocol (VOIP), an interactive voice response (IVR) call is rendered and control option displayed at the user device 406 by rendering voice playback at the user device. Simultaneously, a call interface is displayed at the user device. The steps 316 and 317 jointly correspond to the steps 104 and 105 of FIG. 1. The present IVR call may also be accompanied with multimedia messages such as video and graphics along with text and audio, such that IVR call may be combined with graphics to provide a multifaceted user experience.

The voice is pre-recorded or generated from text. The voice playback comprises rendering at least one of a single-party call for conveying information, an IVR call, and, an IVR or non-IVR call with multimedia playback support. Flow of an Automated IVR, system is designed to support Nth level IVR with complex tree structure. The call interface during the IVR call facilitates user input capturing.

A customized call screen at the user device 406 provides options similar to a standard phone call apps available on mobile devices. The SDK at the user device 406 allows the user to punch in or press the button on call screen too provide their inputs using the keypads with keys ranging from 0-9, * and #. The rendered IVR phone call facilitates decision making and flow control based on inputs. The SDK at the user device 406 works as a state machine, and decides which state shall it transition into after receiving input. Hence, it allows different kind of use cases, such as Surveys, Feedback Collection, Promotions (Scratchcards) as well as Voice OTPs (for accessibility). The system can also double up as an enabler for regulatory compliances. Overall, the user device 406 along with server 404 renders a VOIP enabled IVR support which executes on the client side and allows a campaigner or business to run nth level-dynamic IVR flows and collect end user inputs.

The ongoing call interface is designed based on the operating system SDK to render a phone call display. The ongoing call interface allows the user to provide inputs using at least one of a keypad of the user device, said keypad comprising input keys ranging from digits (0-9), plurality of special characters to provide a user control over the voice playback; and one or more links embedded within the keypad of the call interface to help user navigate within an application of the user device. In an example, the application is invokable based on pressing of the keypad in response to verbal direction imparted during the ongoing call. The application may be exclusively related to the subject matter of current call. For example, if the IVR call is about teaching steps how to reacharge balance of wallet, the application may be an online wallet application.

At step 318 at the user device 406, a log of all push notification enabled voice calls which may be IVR call is created based on Data collection for future use. The inputs provided by the users are automatically captured and stowed away into the server in the form of events.

When millions of users are to be contacted/updated in a short period of time, a state of the art or a conventionally available PSTN mass blast campaign is known to complete in 1 hour so as to reach 1 mn users with a call. A call duration of about a minute(1) take 555E1's (PSTN) which is extremely costly. In other words and in an example, if there is a customer or business who has 10E1's and wishes to contact 1 million subscribers, it normally takes 55 hours to dial out to all those 1 million users through PSTN. Moreover, usage of PSTN for mass blast service requires personal contact numbers of users, thereby not complying with privacy standards such as PII data requirement.

However, the server 404 in accordance with present subject matter incurs a very short time span of say 15 mins or lesser, while the calling scale or outreach of mass blast campaign executed through the server is reachable as higher as 10 million users, thereby being highly cost and time effective. Moreover, there is no requirement by the server 404 to enable these calls via phone numbers or any other contact details, thereby not requiring storage of personal data.

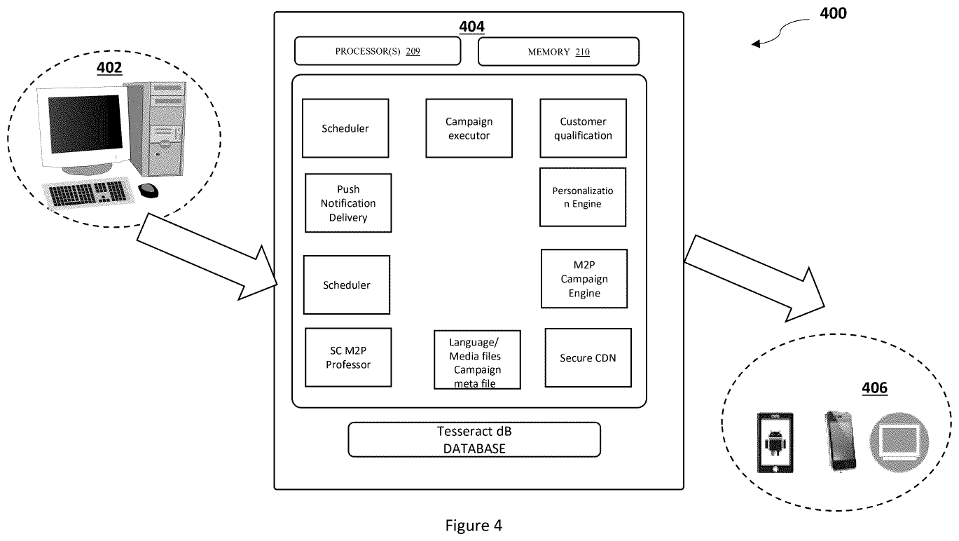

FIG. 4 illustrates a distributed computing-system implementation of FIG. 3 according to an embodiment of the present disclosure. Each of the network nodes 402, 404 and 406 of the networking environment 400 in FIG. 3 may be a stand alone computing system. For sake of brevity, following description refers computing system implementation only for the server 404, although the same may apply for 402 and 406 as well.

The server 404 may essentially comprises one or more processors 209 that in turn may include different modules that are equivalent to the modules performing steps 303 to 315 in FIG. 3 and are therefore not explained here for the sake of brevity. The device 404 may be part of a larger computer system and/or maybe operatively coupled to a computer network (a “network”) with the aid of a communication interface to facilitate the transmission of and sharing data and predictive results. The computer network may be a local area network, an intranet and/or extranet, an intranet and/or extranet that is in communication with the Internet, or the Internet. The computer network in some cases is a telecommunication and/or a data network, and may include one or more computer servers. The computer network, in some cases with the aid of a computer system, may implement a peer-to-peer network, which may enable devices coupled to the computer system to behave as a client or a server.

The device 404 may also include memory 210 or memory locations (e.g., random-access memory, read-only memory, flash memory), electronic storage units (e.g., hard disks) communication interfaces (e.g., network adapters) for communicating with one or more other systems, and peripheral devices, such as cache, other memory, data storage, and/or electronic display adapters.

The one or more processors e.g., a CPU, execute a sequence of machine-readable instructions, which are embodied in a program (or software). The instructions are stored in a memory location. The instructions are directed to the CPU, which subsequently program or otherwise configure the CPU to implement the methods of the present disclosure. Examples of operations performed by the CPU include fetch, decode, execute, and write back. The CPU may be part of a circuit, such as an integrated circuit. One or more other components of the system may be included in the circuit. In some cases, the circuit is an application-specific integrated circuit (ASIC).

The device 404 also comprises one or more IO Managers as software instructions that may run on the one or more processors and implement various communication protocols such as User Datagram Protocol (UDP), Modbus, MQ Telemetry Transport (MQTT), Open Platform Communications Unified Architecture (OPC UA), Semiconductor's equipment interface protocol for equipment-to-host data communications (SECS/GEM), Profinet, or any other protocol, to access data in real-time from disparate data sources via any communication network, such as Ethernet, Wi-Fi, Universal Serial Bus (USB), Zigbee, Cellular or 5G connectivity, etc., or indirectly through a device's primary controller, through a Programmable Logic Controller (PLC) or through a Data Acquisition System (DAQ), or any other such mechanism.

In an embodiment, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

Unlike a conventional mass blast service provider, the present subject matter defined the system 400 doesn't require any real phone number of the end consumer, thereby adhering to user privacy. The present subject matter is operable even in an area which is constrained by the lack of telephony infra and yet has a mass outreach of about 100 mn users in a matter of minutes. This contrasts with state of the art PSTN service provider that will otherwise incur time span to the extent of hours or days for comparable mass blast service. PSTN providers lack and find it hard to adhere to local govt's rules set for businesses making marketing calls to end consumers. On the other hand, the present subject matter is precise, time, cost and technology efficient. Last but not the least, the call arrives inside end user's own App, there being authentic information.

The present subject matter overall provides an improved communication pertaining to delivering messages like a phone call, thereby keeping the facade of the message as being urgent, while not using any telecom infrastructure except public internet.

The terms “comprising,” “including,” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the networks, devices, and/or modules described herein contain optional features that can be individually or together applied to any other embodiment shown or contemplated here to be mixed and matched with the features of such networks, devices, and/or modules.

While the invention has been described with respect to a limited number of embodiments, those skilled in the art, having benefit of this disclosure, will appreciate that other embodiments can be devised which do not depart from the scope of the invention as disclosed herein.

We claim

1. A method implemented at a network node in a client server architecture for communicating with a smartphone user based on multi-media data download over a network:
delivering a push-notification comprising at least a meta-file to a smartphone-based user-device,
receiving a media information from the user-device upon receipt of the push notification at the user device;
upon receiving the media information from the user device, initiating downloading of the meta file and optionally a multimedia data file at the user-device based on determining a configuration of the user device from the received media information, wherein said initiating of downloading comprises incorporating a payload within the push notification as at least one of:
a) natural language text based on download of a language file if the meta file as well as configuration of the user device supports a text to speech conversion; and
b) natural language voice based on download of an additional multimedia file if the meta file does not support the text to speech conversion irrespective of configuration of the user device;
rendering the push notification with the payload as an incoming phone-call alert at the user device upon the downloading; and
rendering voice playback at the user device based on the attending of the incoming call alert and simultaneously displaying an ongoing call interface at the user device, wherein the voice playback is based on either the natural language voice or voice prompts generated from natural language text.

2. The method as claimed in claim 1, wherein the meta file is embedded with at least one of:
a) a URL to reference the multimedia data file and the additional multimedia file located at the remote server; and
b) an interactive voice response (IVR) flow

3. The method as claimed in claim 1, wherein the receiving of the media information comprise determining the configuration of the user device as at least one of a user preference, a preferred language, a compatibility with the text to speech conversion device capability or a network bandwidth available at the user device.

4. The method as claimed in claim 1, wherein the rendering of the push notification comprises displaying a telephone call ring alert as at least one of:
a) a telephonic call alert;
b) a customer call alert annotated with rich media text about call intent/context;
c) a custom display comprising logo and color annotated with call intent/content; and
d) a smartphone operating system phone call application.

5. The method as claimed in claim 1, wherein the downloading of the additional multimedia file comprises downloading voice files to provide custom static voice options.

6. The method as claimed in claim 1, wherein the downloading of the language file comprising natural language text triggers generation of voice prompts by an operating system SDK of the user device using a pre-installed text to speech converted (TTS) engine at the user device.

7. The method as claimed in claim 1, wherein the ongoing call interface is designed based on the operating system SDK to render a phone call display.

8. The method as claimed in claim 1, wherein the ongoing call interface allows the user to provide inputs using at least one of:
a) a keypad of the user device, said keypad comprising input keys ranging from digits (0-9)
b) plurality of special characters to provide a user control over the voice playback; and
c) one or more links embedded within the keypad of the call interface to help user navigate within an application of the user device, wherein said application is invokable based on pressing of the keypad in response to verbal direction imparted during the ongoing call.

9. The method as claimed in claim 1, wherein rendering the voice playback comprises rendering at least one of:
A) a single-party call for conveying information
B) an IVR call; and
C) an IVR or non-IVR call with multimedia playback support.

10. The method as claimed in claim 1, wherein the downloading of the language file comprises downloading at least one of:
a) a default language file; or
b) a user-preferred language file determined based on at least one of:
i) the configuration obtained from the user device; and
ii) a user-preference obtained from the server or cloud and present into the push notification.

11. The method as claimed in claim 6, wherein the generation of the voice prompts from the language-file further comprises:
generating personalized voice prompts based on user data generated in real time by the user device or user data stored at the server.

12. The method as claimed in claim 1, further comprising:
aborting the process in case the meta file mandates the text to speech conversion for call for the user device otherwise incompatible with the text to speech conversion.
